(19) United States
(12) Patent Application Publication
(10) Pub. No.: US 2025/0184233 A1
(43) Pub. Date: Jun. 5, 2025

(54) REGISTRATION OF MACHINE LEARNING (ML) MODEL DRIFT MONITORING

(71) Applicant: Telefonaktiebolaget LM Ericsson (publ), Stockholm (SE)

(72) Inventors: Miguel Angel Garcia Martin, Madrid (ES); Ulf Mattsson, Kungsbacka (SE); Miguel Angel Monjas Llorente, Madrid (ES); Zhang Fu, Stockholm (SE); Danesh Daroui, Göteborg (SE)

(21) Appl. No.: 18/834,511

(22) PCT Filed: Mar. 20, 2023
(86) PCT No.: PCT/IB2023/052719

§ 371 Date: Jul. 30, 2024

(30) Foreign Application Priority Data
Mar. 30, 2022 (EP) 22382302.2

(51) Int. Cl. H04L 41/16; H04L 41/14

(52) U.S. Cl. CPC H04L 41/16; H04L 41/145

(57) ABSTRACT

Embodiments include methods for a model training logical function (MTLF) of a network data analytics function (NWDAF) of a communication network. Such methods include receiving a message indicating that a first analytics logical function (AnLF) of the NWDAF is, or is capable of, monitoring drift of a machine learning (ML) model. Such methods also include, based on the message, sending a subscription request for drift monitoring notifications, by the first AnLF, that are associated with the ML model. Other embodiments include complementary methods for the first AnLF and for a common registration repository, as well as MTLFs, AnLFs, and common registration repositories configured to perform such methods.

### TECHNICAL FIELD

The present application relates generally to the field of communication networks, and more specifically to techniques for generating analytics in a communication network based on machine learning (ML) models, including monitoring and/or supervision of such models used in 5G core (5GC) networks.

### INTRODUCTION

Currently the fifth generation (“5G”) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

At a high level, the 5G System (5GS) consists of an Access Network (AN) and a Core Network (CN). The AN provides UEs connectivity to the CN, e.g., via base stations such as gNBs or ng-eNBs described below. The CN includes a variety of Network Functions (NF) that provide a wide range of different functionalities such as session management, connection management, charging, authentication, etc.

FIG. 1 illustrates a high-level view of an exemplary 5G wireless network 100, which includes a Next Generation Radio Access Network (NG-RAN, 199) and a 5G Core (5GC, 198). The NG-RAN can include one or more gNodeB's (gNBs, e.g., 100, 152) connected to the 5GC via one or more NG interfaces (e.g., 102, 152). More specifically, gNBs can be connected to one or more access and mobility management functions (AMFs) in the 5GC via respective NG-C interfaces. Similarly, gNBs can be connected to one or more user plane functions (UPFs) in 5GC via respective NG-U interfaces. Various other network functions (NFs) can be included in the 5GC, as described in more detail below.

In addition, the gNBs can be connected to each other via one or more Xn interfaces (e.g., 140 between gNBs 100 and 150). The radio technology for the NG-RAN is often referred to as “New Radio” (NR). For communication with UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells.

The NG-RAN is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

The NG RAN logical nodes shown in FIG. 1 include a Central Unit (CU or gNB-CU) and one or more Distributed Units (DU or gNB-DU). For example, gNB 100 includes gNB-CU 110 and gNB-DUs 120 and 130. CUs are logical nodes that host higher-layer protocols and perform various gNB functions such controlling the operation of DUs. DUs are decentralized logical node that hosts lower layer protocols and can include, depending on the functional split option, various subsets of the gNB functions. As such, each CU or DU can include various circuitry needed to perform their respective functions, including processing circuitry, transceiver circuitry (e.g., for communication), and power supply circuitry.

A gNB-CU connects to one or more gNB-DUs over respective F1 logical interfaces (e.g., 122, 132). However, a gNB-DU can be connected to only a single gNB-CU. The gNB-CU and connected gNB-DU(s) are only visible to other gNBs and the 5GC as a gNB. In other words, the F1 interface is not visible beyond gNB-CU.

Another change in 5G networks (e.g., in 5GC) is that traditional peer-to-peer interfaces and protocols found in earlier-generation networks are modified and/or replaced by a Service Based Architecture (SBA) in which Network Functions (NFs) provide one or more services to one or more service consumers. This can be done, for example, by Hyper Text Transfer Protocol/Representational State Transfer (HTTP/REST) application programming interfaces (APIs). In general, the various services are self-contained functionalities that can be changed and modified in an isolated manner without affecting other services.

Furthermore, the services are composed of various “service operations”, which are more granular divisions of the overall service functionality. The interactions between service consumers and producers can be of the type “request/response” or “subscribe/notify”. In the 5G SBA, network repository functions (NRF) allow every network function to discover the services offered by other network functions, and Data Storage Functions (DSF) allow every network function to store its context. This 5G SBA model is based on principles including modularity, reusability and self-containment of NFs, which can enable network deployments to take advantage of the latest virtualization and software technologies.

A 5GC NF that is of particular interest in the present disclosure is the Network Data Analytics Function (NWDAF). This NF provides network analytics information (e.g., statistical information of past events and/or predictive information) to other NFs on a network slice instance level. The NWDAF can collect data from any 5GC NF. Note that a “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice.

Machine learning (ML) is a type of artificial intelligence (AI) that focuses on the use of data and algorithms to imitate the way that humans learn, gradually improving its accuracy. ML algorithms build models based on sample (or “training”) data, with the models being used subsequently to make predictions or decisions. ML algorithms can be used in a wide variety of applications (e.g., medicine, email filtering, speech recognition, etc.) in which it is difficult or unfeasible to develop conventional algorithms to perform the needed tasks. A subset of ML is closely related to computational statistics.

3GPP TS 23.288 (v17.2.0) specifies NWDAF as the main NF for computing analytics reports, and classifies NWDAF into two sub-functions (or logical functions): Analytics Logical Function (AnLF or NWDAF (AnLF)), which performs analytics procedures; and Model Training Logical Function (MTLF or NWDAF (MTLF)), which performs training and retraining of ML models used by NWDAF (AnLF).

### SUMMARY

It is expected that ML models will degrade (or “drift”) over time, such that the NWDAF (MTLF) will need to retrain a degraded model or replace it with a new model. In some cases, an NWDAF (AnLF) may monitor the drift of one or more of the ML models it is using. Currently, however, there is no way for an NWDAF (MTLF) to inquire or to be informed about whether an NWDAF (AnLF) is monitoring a particular ML model. For example, if the NWDAF (MTLF) provides an ML model to multiple NWDAF (AnLF), it remains unaware of which (if any) of the multiple NWDAF (AnLF) are monitoring the ML model.

An object of embodiments of the present disclosure is to facilitate the otherwise-advantageous deployment of ML models for network analytics by addressing these and other problems, issues, and/or difficulties.

Some embodiments of the present disclosure include methods (e.g., procedures) for an NWDAF (MTLF) of a communication network (e.g., 5GC). These exemplary methods can include receiving a message indicating that a first AnLF of the NWDAF is, or is capable of, monitoring drift of an ML model. These exemplary methods can also include, based on the message, sending a subscription request for drift monitoring notifications, by the first AnLF, that are associated with the ML model. In some embodiments, these exemplary methods can also include receiving one or more drift monitoring notifications from the first AnLF in accordance with the subscription request.

In some embodiments, these exemplary methods can also include sending the ML model to one or more AnLFs, including the first AnLF. In some of these embodiments, the message is one of the following:
a registration request indicating that the first AnLF is monitoring the ML model, received from the first AnLF after sending the ML model;
a subscription request or an information request for an ML model, which indicates that the first AnLF is capable of monitoring drift of ML models and is received from the first AnLF before sending the ML model; or
a query response from a common registration repository, which indicates that the first AnLF is monitoring drift of the ML model and is received from the common registration repository after sending the ML model.

In some of these embodiments, these exemplary methods can also include sending, to the common registration repository, a query for a list of AnLFs that have registered as monitoring or being capable of monitoring drift of the ML model. In such case, the query response is received from the common registration repository in response to the query. In other of these embodiments, these exemplary methods can also include sending to the AnLF a response indicating acknowledgement of the registration request, subscription request, or information request received from the first AnLF.

In various embodiments, the message can include one or more of the following information:
a unique identifier of the ML model;
an identifier of the first AnLF or of a drift detection logical function (DDLF) of the first AnLF that is, or is capable of, performing the drift monitoring;
one or more analytics identifiers associated with the drift monitoring;
one or more ML model identifiers associated with the drift monitoring;
an identifier of an analytics target for which the drift monitoring is being performed;
an address for drift monitoring subscription requests;
filtering criteria for the drift monitoring; and
an ML model subscription identifier.

In some of these embodiments one or more of the following applies:
the subscription request is sent to the address for drift monitoring subscription requests, included in the message; and
the subscription request includes at least a portion of the information included with the message.

Other embodiments include exemplary methods (e.g., procedures) for an NWDAF (AnLF) of a communication network (e.g., 5GC). These exemplary methods can include sending a message indicating that the AnLF is, or is capable of, monitoring drift of an ML model. These exemplary methods can also include subsequently receiving, from an MTLF of the NWDAF, a subscription request for drift monitoring notifications associated with the ML model.

In some embodiments, these exemplary methods can also include receiving the ML model from the MTLF. In some of these embodiments, the message is one of the following:
a registration request indicating that the AnLF is monitoring the ML model, with the registration request being sent the MTLF after receiving the ML model;
a subscription request or an information request for an ML model, which indicates that the AnLF is capable of monitoring drift of ML models and is sent to the MTLF before receiving the ML model; or
a registration request to a common registration repository, which indicates that the first AnLF is monitoring drift of the ML model and is sent to the common registration repository after receiving the ML model.

In some of these embodiments, these exemplary methods can also include receiving, from the AnLF or the common registration repository, a response indicating acknowledgement of the message.

In various embodiments, the message can include any of the information summarized above for MTLF embodiments. In some embodiments, one or more of the following applies:
the subscription request is received at the address for drift monitoring subscription requests, included in the message; and
the subscription request includes at least a portion of the information included with the message.

Other embodiments include methods (e.g., procedures) for common registration repository of a communication network (e.g., 5GC). These exemplary methods can include receiving, from a first AnLF of an NWDAF of the communication network, a registration request that indicates the first AnLF is, or is capable of, monitoring drift of an ML model provisioned by an MTLF of the NWDAF. These exemplary methods can also include receiving, from the MTLF, a query for a list of AnLFs that have registered as monitoring or being capable of monitoring drift of the ML model. These exemplary methods can also include, based on the registration request, sending to the MTLF a query response that includes information identifying the first AnLF.

In some embodiments, these exemplary methods can also include sending to the first AnLF a response indicating acknowledgement of the registration request.

In various embodiments, the registration request can include any of the information summarized above for the message in MTLF embodiments.

In some embodiments, the query includes a unique identifier of the ML model and these exemplary methods also include the following operations: storing the information received with the registration request; and retrieving, from the stored information based on the unique identifier of the ML model included with the query, the information identifying the first AnLF that is included in the query response.

In some embodiments, the common registration repository is a UDR of a 5GC. In other embodiments, the common registration repository is an ADRF of a 5GC.

Other embodiments include NWDAF (MTLF) s, NWDAF (AnLF) s, and common registration repositories (or network nodes hosting the same) that are configured to perform the operations corresponding to any of the exemplary methods described herein. Other embodiments also include non-transitory, computer-readable media storing computer-executable instructions that, when executed by processing circuitry, configure such NWDAF (MTLF) s, NWDAF (AnLF) s, and common registration repositories to perform operations corresponding to any of the exemplary methods described herein.

These and other disclosed embodiments facilitate timely indication of ML model drift to an NWDAF (MTLF), which can retrain the ML model before the inaccuracy due to drift reaches an unacceptable level, e.g., in advance of a periodic and/or predefined model retraining event. Alternately, the NWDAF (MTLF) can trigger termination of the ML model when the detected drift and/or inaccuracy becomes too severe. reports. These advantages are facilitated by providing the NWDAF (MTLF) with a way to determine which NWDAF (AnLF) is monitoring drift of the ML model, so the NWDAF (MTLF) can subscribe for drift notifications. More generally, embodiments facilitate deployment of ML models for analytics in a communication network such as a 5GC.

These and other objects, features, and advantages of the present disclosure will become apparent upon reading the following Detailed Description in view of the Drawings briefly described below.

### BRIEF DESCRIPTION OF THE DRAWINGS

FIGS. 1-2 illustrate various aspects of an exemplary 5G network architecture.

FIG. 3 shows an exemplary procedure for an NWDAF service consumer to subscribe for notifications about ML model availability from an NWDAF (MTLF).

FIG. 4 shows an exemplary procedure for an NWDAF service consumer to retrieve information about ML model(s) from an NWDAF (MTLF).

FIG. 5 shows a block diagram of an NWDAF.

FIGS. 6-8 show signal flow diagrams of various exemplary registration procedures for drift monitoring of an ML model, according to various embodiments of the present disclosure.

FIG. 9 shows an exemplary method (e.g., procedure) for an NWDAF (MTLF) of a communication network, according to various embodiments of the present disclosure.

FIG. 10 shows an exemplary method (e.g., procedure) for an NWDAF (AnLF) of a communication network, according to various embodiments of the present disclosure.

FIG. 11 shows an exemplary method (e.g., procedure) for a common registration repository of a communication network, according to various embodiments of the present disclosure.

FIG. 12 shows a communication system according to various embodiments of the present disclosure.

FIG. 13 shows a UE according to various embodiments of the present disclosure.

FIG. 14 shows a network node according to various embodiments of the present disclosure.

FIG. 15 shows host computing system according to various embodiments of the present disclosure.

FIG. 16 is a block diagram of a virtualization environment in which functions implemented by some embodiments of the present disclosure may be virtualized.

FIG. 17 illustrates communication between a host computing system, a network node, and a UE via multiple connections, according to various embodiments of the present disclosure.

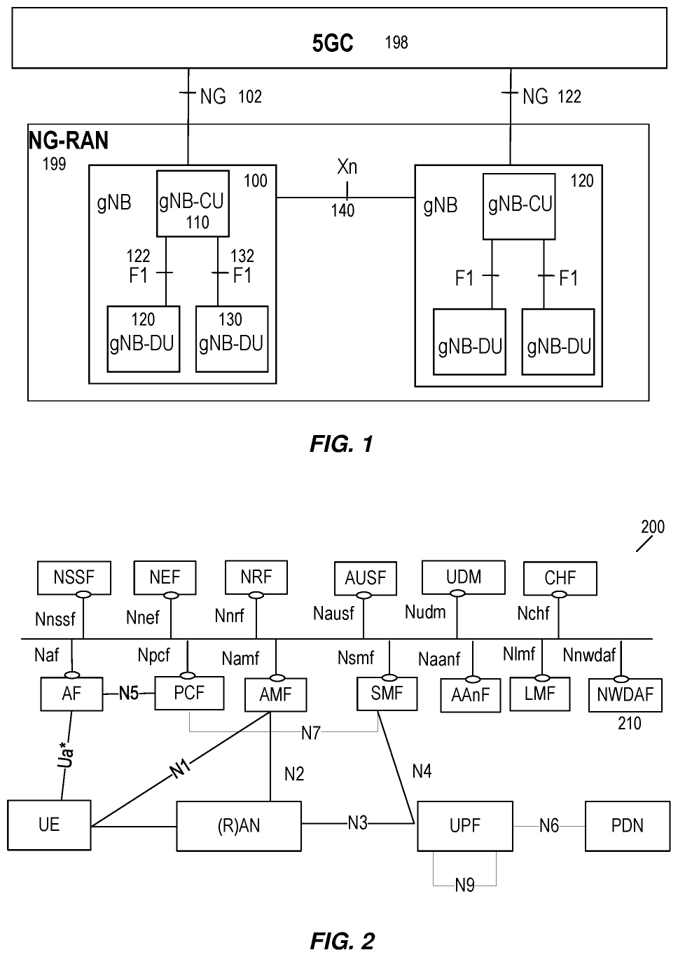

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features and advantages of the disclosed embodiments will be apparent from the following description.

Furthermore, the following terms are used throughout the description given below:
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB) in a 3GPP Fifth Generation (5G) NR network or an enhanced or evolved Node B (eNB) in a 3GPP LTE network), base station distributed components (e.g., CU and DU), a high-power or macro base station, a low-power base station (e.g., micro, pico, femto, or home base station, or the like), an integrated access backhaul (IAB) node (or component thereof such as MT or DU), a transmission point, a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a Packet Data Network Gateway (P-GW), etc. A core network node can also be a node that implements a particular core network function (NF), such as an access and mobility management function (AMF), a session management function (SMF), a user plane function (UPF), a Service Capability Exposure Function (SCEF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without any prefix) can be any type of node that is capable of operating in or with a wireless network (including a RAN and/or a core network), including a radio access node (or equivalent term), core network node, or wireless device. However, the term “node” may be limited to a particular type of node (e.g., radio access node) based on its specific characteristics in any context of use.
Service: As used herein, the term “service” refers generally to a set of data, associated with one or more applications, that is to be transferred via a network with certain specific delivery requirements that need to be fulfilled in order to make the applications successful.
Component: As used herein, the term “component” refers generally to any component needed for the delivery of a service. Examples of component are RANs (e.g., E-UTRAN, NG-RAN, or portions thereof such as eNBs, gNBs, base stations (BS), etc.), CNs (e.g., EPC, 5GC, or portions thereof, including all type of links between RAN and CN entities), and cloud infrastructure with related resources such as computation, storage. In general, each component can have a “manager”, which is an entity that can collect historical information about utilization of resources as well as provide information about the current and the predicted future availability of resources associated with that component (e.g., a RAN manager).

Note that the description given herein focuses on a 3GPP cellular communications system and, as such, 3GPP terminology or terminology similar to 3GPP terminology is generally used. However, the concepts disclosed herein are not limited to a 3GPP system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from the concepts, principles, and/or embodiments described herein.

In addition, functions and/or operations described herein as being performed by a wireless device or a network node may be distributed over a plurality of wireless devices and/or network nodes. Furthermore, although the term “cell” is used herein, it should be understood that (particularly with respect to 5G NR) beams may be used instead of cells and, as such, concepts described herein apply equally to both cells and beams.

FIG. 2 shows an exemplary non-roaming architecture of a 5G network (200) with service-based interfaces. This architecture includes the following 3GPP-defined NFs:
Application Function (AF, with Naf interface) interacts with the 5GC to provision information to the network operator and to subscribe to certain events happening in operator's network. An AF offers applications for which service is delivered in a different layer (i.e., transport layer) than the one in which the service has been requested (i.e., signaling layer), the control of flow resources according to what has been negotiated with the network. An AF communicates dynamic session information to PCF (via N5 interface), including description of media to be delivered by transport layer.
Policy Control Function (PCF, with Npcf interface) supports unified policy framework to govern the network behavior, via providing PCC rules (e.g., on the treatment of each service data flow that is under PCC control) to the SMF via the N7 reference point. PCF provides policy control decisions and flow based charging control, including service data flow detection, gating, QoS, and flow-based charging (except credit management) towards the SMF. The PCF receives session and media related information from the AF and informs the AF of traffic (or user) plane events.
User Plane Function (UPF)-supports handling of user plane traffic based on the rules received from SMF, including packet inspection and different enforcement actions (e.g., event detection and reporting). UPFs communicate with the RAN (e.g., NG-RNA) via the N3 reference point, with SMFs (discussed below) via the N4 reference point, and with an external packet data network (PDN) via the N6 reference point. The N9 reference point is for communication between two UPFs.
Session Management Function (SMF, with Nsmf interface) interacts with the decoupled traffic (or user) plane, including creating, updating, and removing Protocol Data Unit (PDU) sessions and managing session context with the User Plane Function (UPF), e.g., for event reporting. For example, SMF performs data flow detection (based on filter definitions included in PCC rules), online and offline charging interactions, and policy enforcement.
Charging Function (CHF, with Nchf interface) is responsible for converged online charging and offline charging functionalities. It provides quota management (for online charging), re-authorization triggers, rating conditions, etc. and is notified about usage reports from the SMF. Quota management involves granting a specific number of units (e.g., bytes, seconds) for a service. CHF also interacts with billing systems.
Access and Mobility Management Function (AMF, with Namf interface) terminates the RAN CP interface and handles all mobility and connection management of UEs (similar to MME in EPC). AMFs communicate with UEs via the N1 reference point and with the RAN (e.g., NG-RAN) via the N2 reference point.
Network Exposure Function (NEF) with Nnef interface—acts as the entry point into operator's network, by securely exposing to AFs the network capabilities and events provided by 3GPP NFs and by providing ways for the AF to securely provide information to 3GPP network. For example, NEF provides a service that allows an AF to provision specific subscription data (e.g., expected UE behavior) for various UEs.
Network Repository Function (NRF) with Nnrf interface—provides service registration and discovery, enabling NFs to identify appropriate services available from other NFs.
Network Slice Selection Function (NSSF) with Nnssf interface—a “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice. The NSSF enables other NFs (e.g., AMF) to identify a network slice instance that is appropriate for a UE's desired service.
Authentication Server Function (AUSF) with Nausf interface—based in a user's home network (HPLMN), it performs user authentication and computes security key materials for various purposes.
Network Data Analytics Function (NWDAF, 210) with Nnwdaf interface, described in more detail above and below.
Location Management Function (LMF) with Nlmf interface-supports various functions related to determination of UE locations, including location determination for a UE and obtaining any of the following: DL location measurements or a location estimate from the UE; UL location measurements from the NG RAN; and non-UE associated assistance data from the NG RAN.

The Unified Data Management (UDM) function supports generation of 3GPP authentication credentials, user identification handling, access authorization based on subscription data, and other subscriber-related functions. To provide this functionality, the UDM uses subscription data (including authentication data) stored in the 5GC unified data repository (UDR). In addition to the UDM, the UDR supports storage and retrieval of policy data by the PCF, as well as storage and retrieval of application data by NEF.

The NRF allows every NF to discover the services offered by other NFs, and Data Storage Functions (DSF) allow every NF to store its context. In addition, the NEF provides exposure of capabilities and events of the 5GC to AFs within and outside of the 5GC. For example, NEF provides a service that allows an AF to provision specific subscription data (e.g., expected UE behavior) for various UEs.

Communication links between the UE and a 5G network (AN and CN) can be grouped in two different strata. The UE communicates with the CN over the Non-Access Stratum (NAS), and with the AN over the Access Stratum (AS). All the NAS communication takes place between the UE and the AMF via the NAS protocol (N1 interface in FIG. 2). Security for the communications over this these strata is provided by the NAS protocol (for NAS) and the PDCP protocol (for AS).

3GPP Rel-17 enhances the SBA by adding a Data Management Framework that includes a Data Collection Coordination Function (DCCF) and a Messaging Framework Adaptor Function (MFAF), which are defined in detail in 3GPP TR 23.700-91 (v17.0.0). The Data Management Framework is backward compatible with a Rel-16 NWDAF function, described above. For Rel-17, the baseline for services offered by the DCCF (e.g., to an NWDAF Analytics Function) are the Rel-16 NF Services used to obtain data. For example, the baseline for the DCCF service used by an NWDAF consumer to obtain UE mobility data is Namf_EventExposure.

As mentioned above, 3GPP TS 23.288 (v17.2.0) specifies that NWDAF is the main network function for computing analytics reports. The 5G system architecture allows any NF to obtain analytics from an NWDAF using a DCCF function and associated Ndccf services. The NWDAF can also perform storage and retrieval of analytics information from an Analytics Data Repository Function (ADRF).

3GPP TS 23.288 also classifies NWDAF into two sub-functions (or logical functions): NWDAF Analytics Logical Function (NWDAF AnLF), which performs analytics procedures; and NWDAF Model Training Logical Function (NWDAF MTLF), which performs training and retraining of ML models used by NWDAF AnLF.

3GPP TS 23.288 specifies a subscribe/notify procedure for a consumer NF to retrieve ML model(s) associated with one or more Analytics IDs whenever a new ML model has been trained by the NWDAF MTLF and becomes available. This is referred to as ML Model Provisioning and is implemented by the Nnwdaf_MLModelProvision service.

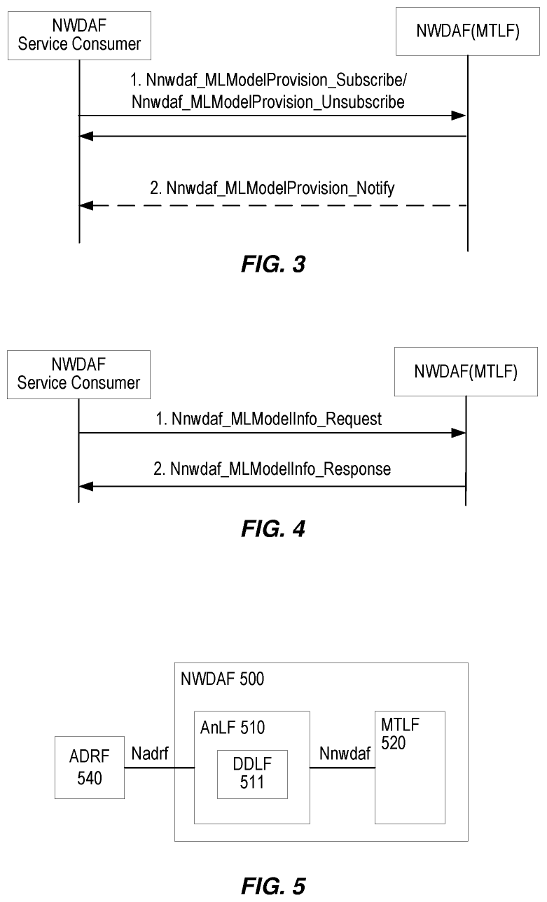

FIG. 3 shows an exemplary procedure for an NWDAF service consumer (e.g., NWDAF (AnLF) to subscribe for notifications about ML model availability from a NWDAF (MTLF). As mentioned above, the procedure is implemented based on Nnwdaf_MLModelProvision_Subscribe and Nnwdaf_MLModelProvision_Notify messages that are part of the Nnwdaf_MLModelProvision service. 3GPP TS 23.288 section 6.2A describes the procedure in more detail.

3GPP TS 23.288 also specifies a request/response procedure for consumer NF (e.g., NWDAF AnLF) to retrieve information about ML model(s) associated with one or more Analytics IDs. This procedure is implemented by the Nnwdaf_MLModelInfo service and is illustrated in FIG. 4.

As briefly mentioned above, it is expected that ML models will degrade over time, such that retraining of a degraded model or replacement by a new model will be needed. 3GPP TS 23.288 specifies that NWDAF MTLF may determine that further training for an existing ML model is needed but provides no guidelines and/or requirements for this determination.

One possible solution recognized by applicant is an NWDAF Drift Detector Logical Function, NWDAF (DDLF), that monitors whether ML model drift has occurred. The NWDAF (DDLF) can inform NWDAF (MTLF) of an observed level of drift of an ML model. NWDAF (MTLF) can use this information for triggering a retraining of the ML model, as needed, in a timely manner. For example, the NWDAF (MTLF) can detect in advance a trend of decreasing reliability of the results produced by the ML model, even though the results are still within a valid range. As such, NWDAF (MTLF) can determine whether ML model retraining is needed before results become invalid. Furthermore, the NWDAF (MTLF) can notify the NWDAF (AnLF) not only when a new ML model release is available (as currently) but also when the ML model must be terminated due to severe degradation.

For example, an NWDAF (DDLF) can perform drift monitoring on one or more of the following, each of which can be referred to as a “monitoring object”:
Raw data acquisition, i.e., the raw data that the NWDAF (AnLF) is acquiring for analytics computation. This raw data may be stored in an ADRF or even in the NWDAF (AnLF) itself, from which the NWDAF (DDLF) can retrieve the data of interest. Alternatively, the NWDAF (DDLF) can subscribe to the data as it is being produced in real time, perhaps through a DCCF/MFAF. In any case, the NWDAF (DDLF) has access to the real raw data produced by the different network functions.
Feature vectors, which are created by NWDAF (AnLF) as part of the data pre-processing and feature engineering stages in the inference pipeline so that they are the actual input of an ML model.
Predictions (e.g., analytics reports), with corresponding actual values evaluated when the prediction becomes present.

FIG. 5 shows a block diagram of an exemplary NWDAF (500) that includes a DDLF (511). In this example, the DDLF is part of the AnLF (510). The AnLF communicates with an ADRF (540) via Nadrf services and with the MTLF (520) via Nnwdaf services.

If an ADRF or a DCCF are deployed in the network, the DDLF can use the Nadrf or Ndccf services to request either the collected data from the past or a subscription to real-time data and carries out drift monitoring operations on the monitoring objects. Therefore, it might be necessary to configure 5GC NFs so that data associated to each of the monitoring objects listed above is stored and made available to the DDLF:
Raw data storage can be by the NWDAF (AnLF) or by the NFs themselves.
Feature vectors are stored by the NWDAF (AnLF).
Prediction storage may be handled by the NWDAF (AnLF) or by the NFs that consume analytics reports. Actual value storage can be handled by the NWDAF (AnLF) (e.g., if it receives the actual values, such as in some UE mobility scenarios) or by the NFs that consume analytics reports since they usually are able to compare predictions with actual values.

Monitoring of the first two monitoring objects can be used to detect so-called “data drift”, e.g., whether there has been a change in the distribution of input data. In such case, monitoring can include execution of one or more data drift tests to the corresponding data. Monitoring of the third monitoring object can be used to measure model performance and to detect so-called “concept drift”. In such case, monitoring can include computation of a model performance metric.

To be able to monitor drift at the ML model level, the NWDAF (MTLF) must be able to map Analytics ID(s) to ML model IDs, so that it can request and receive drift notifications at ML model level from the NWDAF (AnLF).

The DDLF should be able to access a drift detection configuration specific to each Analytics ID or relevant scope. For example, a single ML model (e.g., with a model ID) can support different Analytics IDs or, conversely, a single Analytics ID can be served by several ML models (e.g., with different model IDs). A drift detection configuration can specify which monitoring objects are supported. For each supported monitoring object, the drift detection configuration can include one or more of the following items:
Generic information about how to access the NF that stores the raw data for verifying drift in the specific monitoring object, e.g., location, credentials, database structure, etc.
Specific information about data in each monitoring object, e.g., data schemas, subset of the data to which drift monitoring tests must be applied. As a more specific example, a raw observation may be made of several attributes, but only some of them are important for the implementation of the ML model. Thus, a data drift test can be limited to these attributed deemed important.
Size or time window of the dataset used to verify drift in the specific monitoring object, as well as any applicable sampling ratio.
For raw data acquisition and feature vectors monitoring objects, identification of supported data drift tests (e.g., Kolmogorov-Smirnov, Kullback-Leibler divergence, etc.) as well as threshold(s) for each supported test.
For the predictions and actual values monitoring object, identification of relevant performance metrics (e.g., Mean Squared Error, Root Mean Squared Error, Mean Absolute Error, etc.) as well as threshold(s) for each relevant performance metric.

For example, some or all of the above-listed items can be part of meta-data associated with each ML model. In such case, DDLF can retrieve the ML model meta-data using the Nnwdaf_MLModelInfo service. The ML model metadata can be structured and/or provisioned in any way that is technically feasible, suitable, and/or convenient.

One way to implement DDLF-based ML model monitoring is by enhancing the existing collection of Nnwdaf services. A new service (e.g., Nnwdaf_MLModelMonitoring) can include service operations that allow the NWDAF (MTLF) to subscribe/unsubscribe and to receive corresponding notifications about the results of the drift monitoring operations.

For example, the NWDAF (AnLF) can subscribe to notifications on the availability of new ML models using a service operation Nnwdaf_MLModelProvision_Subscribe. The NWDAF (AnLF) may store data associated with monitoring objects in ADRF (by means of the service operations included in the services in Nadrf). Likewise, NWDAF (MTLF) subscribes to notifications on drift monitoring provided by the NWDAF (AnLF), i.e., the DDLF functionality. For example, this can be done via service operations Nnwdaf_MLModelMonitoring_Subscribe and Nnwdaf_MLModelMonitoring_Unsubscribe that can be used to initiate, modify, and cancel subscriptions from NWDAF (MTLF).

However, there is currently no way for an NWDAF (MTLF) to inquire or to be informed about whether an NWDAF (AnLF) is monitoring a particular ML model. For example, if the NWDAF (MTLF) provides an ML model to multiple NWDAF (AnLF), it remains unaware of which (if any) of the multiple NWDAF (AnLF) are monitoring the ML model. Without this information, the NWDAF (MTLF) is unable to determine whether to subscribe to ML modeling monitoring via the Nnwdaf_MLModelMonitoring service, e.g., using an Nnwdaf_MLModelMonitoring_Subscribe service operation. Put differently, it is unclear how the NWDAF (MTLF) can initiate a subscription for ML model monitoring at an NWDAF (AnLF).

Embodiments of the present disclosure address these and other problems, issues, and/or difficulties by providing techniques whereby a DDLF in an NWDAF (AnLF) can send a registration request to the NWDAF (MTLF) when it starts monitoring an ML model. The registration request can include one or more of the following information:
a unique identifier of the ML model;
an identifier of the first AnLF or of a DDLF of the first AnLF that is, or is capable of, performing the drift monitoring;
one or more analytics identifiers associated with the drift monitoring;
one or more ML model identifiers associated with the drift monitoring;
an identifier of an analytics target for which the drift monitoring is being performed;
an address for drift monitoring subscription requests;
filtering criteria for the drift monitoring; and
an ML model subscription identifier.
   Similarly, when the DDLF in the NWDAF (AnLF) ceases monitoring the ML model subject to the registration request, it sends a deregistration (or unregister) request to the NWDAF (MTLF).

After receiving the registration request, the NWDAF (MTLF) can send the NWDAF (AnLF) a request for detection. This can be done in response to the registration request, or at any subsequent time when the NWDAF (MTLF) determines that it needs to learn the drift of the ML model identified by the registration request. For example, the NWDAF (MTLF) consults the registration status of various NWDAF (AnLF) to which it provided the ML model and selects at least one of these that have registered for active monitoring of the ML model. In some embodiments, the NWDAF (MTLF) can determine the NF ID and/or ML monitoring subscription endpoint provided by the selected registered NWDAF (AnLF), and send an Nnwdaf_MLModelMonitor_Subscribe request to the selected NWDAF (AnLF).

Embodiments of the present disclosure can provide various benefits and/or advantages. For example, embodiments can facilitate detecting drift of an ML model. Also, an NWDAF (MTLF) can receive information (“drift report”) indicating that an ML model that it is handling is subject to a level of drift that will produce inaccurate results; the NWDAF (MTLF) can analyze successive drift reports to determine a trend. Based on this analysis, the NWDAF (MTLF) can trigger retraining of the ML model before the inaccuracy reaches an unacceptable level, e.g., in advance of a periodic and/or predefined model retraining event. Embodiments also facilitate an NWDAF (MTLF) to trigger termination of an ML model at a NWDAF (AnLF) based on the analysis of the drift reports. These benefits and/or advantages are facilitated by the NWDAF (AnLF) registering with the NWDAF (MTLF) when it starts monitoring an ML model provided by the NWDAF (MTLF).

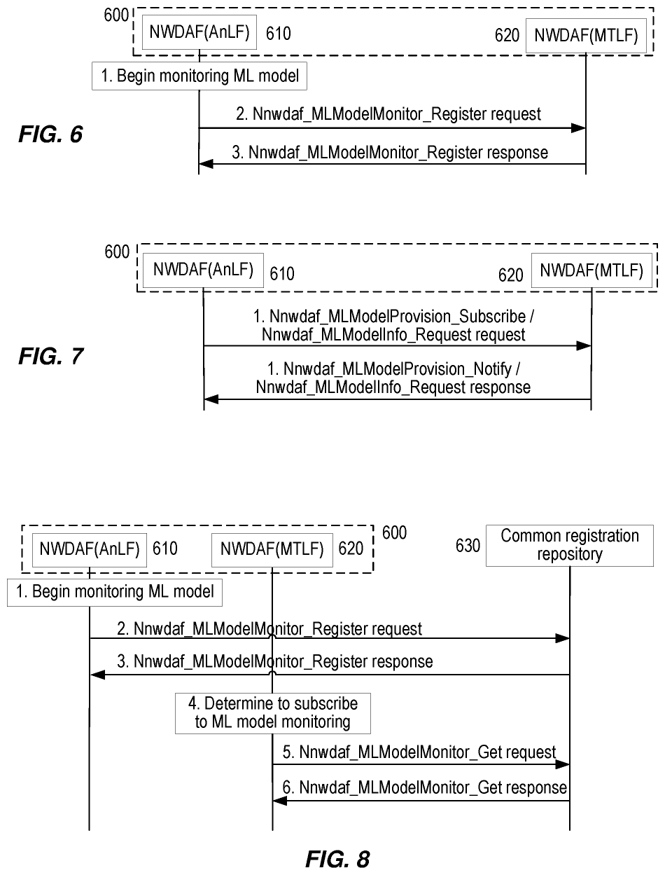

FIG. 6 shows a signal flow diagram of a procedure, according to some embodiments of the present disclosure. The procedure involves an NWDAF (600) that includes an AnLF (610) and an MTLF (620). Even so, substantially the same procedure could be performed between an AnLF and an MTLF in different NWDAF instances. Put differently, the NWDAF shown in FIG. 6 can be implemented as multiple NWDAF instances.

In operation 1, the NWDAF (AnLF) (or DDLF included therein) begins monitoring an ML model for drift and/or degradation. Although not shown, the ML model was previously provisioned to the NWDAF (AnLF) by the NWDAF (MTLF), e.g., for the purpose of producing analytics based on the ML model. In operation 2, after beginning the monitoring, the NWDAF (AnLF) sends an Nnwdaf_MLModelMonitor_Register request, which is a new service operation that can be added to an existing Nnwdaf_MLModelMonitor service.

The Nnwdaf_MLModelMonitor_Register request can include various information, including any of the items listed above in relation to the more generic “registration request”. For example, the NWDAF (AnLF) can include its NF ID, a unique ID of the ML model, and (optionally) a subscription endpoint for the ML monitoring service operation. Based on this information, the NWDAF (MTLF) is aware of that the particular NWDAF (AnLF) is monitoring the particular ML model, and can subscribe to notifications related to the particular ML model (such as shown in FIG. 3).

The NWDAF (MTLF) can respond in operation 3 with an Nnwdaf_MLModelMonitor_Register response, indicating acknowledgement of the registration. When the NWDAF (AnLF) is not long monitoring the particular ML model, it can send the NWDAF (MTLF) an Nnwdaf_MLModelMonitor_Unregister request, which is a new service operation that can be added to an existing Nnwdaf_MLModelMonitor service. The NWDAF (MTLF) can respond to this message in a similar manner, and can delete any data related to the monitoring that it previously stored.

FIG. 7 shows a signal flow diagram of another procedure according to other embodiments of the present disclosure. FIG. 7 involves the same entities as FIG. 6, so the same reference numbers are used. In operation 1, when the NWDAF (AnLF) requests an ML model from the NWDAF (MTLF) via Nnwdaf_MLModelProvision_Subscribe service or Nnwdaf_MLModelInfo_Request service, NWDAF (AnLF) includes in the request a new indication that it supports DDLF functionality and can provide the Nnwdaf_MLModelMonitor service. The NWDAF (AnLF) also includes in the request its NF ID (or an NF ID of the DDLF, if separate) and (optionally) a subscription endpoint of the Nnwdaf_MLMNodelMonitor service operation.

The NWDAF (MTLF) stores the received NF ID and additional supplied information and responds in operation 2 with Nnwdaf_MLModelProvision_Notify or Nnwdaf_MLModelInfo_Request response according to the specific message received in operation 1. Based on the stored information, the NWDAF (MTLF) can subsequently invoke the Nnwdaf_MLModelMonitor Subscribe service with the NWDAF (AnLF) as needed.

FIG. 8 shows a signal flow diagram of another procedure according to other embodiments of the present disclosure. The procedure shown in FIG. 8 involves the same entities as the procedures shown in FIGS. 6-7, as well as a common registration repository (630) for ML model monitoring. For example, the common registration repository can be UDR, ADRF, or any other network node or function for which implementation would be beneficial and technically feasible.

In operation 1, NWDAF (AnLF) begins monitoring an ML model previously provided by NWDAF (MTLF). In operation 2, the NWDAF (AnLF) sends an Nnwdaf_MLModelMonitor_Register request to the common registration repository, and includes its NF ID, a unique ID of the ML model, and (optionally) a subscription endpoint for the ML monitoring service operation. Other information listed above can also be included, as needed or desired. In operation 3, the common registration repository sends an Nnwdaf_MLModelMonitor_Register response to the NWDAF (AnLF), e.g., acknowledging the registration in operation 2.

In operation 4, the NWDAF (MTLF) decides to subscribe to monitoring of the ML model previously provided to one or more NWDAF (AnLF). In operation 5, the NWDAF (MTLF) sends an Nwdaf_MLModelMonitor_Get request to the common registration repository and includes information identifying the ML model of interest. In operation 6, the common registration repository sends an Nwdaf_MLModelMonitor_Get response to the NWDAF (MTLF), and includes information identifying the NWDAF (AnLF) that has registered as monitoring the ML model of interest. Subsequently, the NWDAF (MTLF) can subscribe to that NWDAF (AnLF) for drift monitoring updates about the ML model of interest, such as described in more detail above.

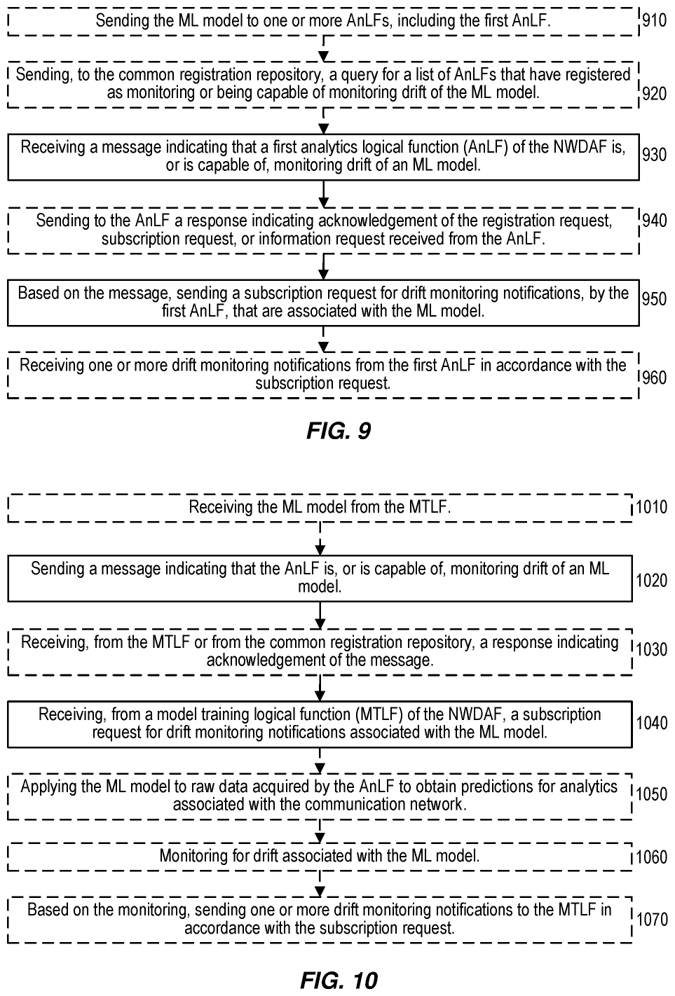

These embodiments described above can be further illustrated with reference to FIGS. 9-11, which depict exemplary methods (e.g., procedures) for an NWDAF (MTLF), an NWDAF (AnLF), and a common registration repository, respectively. Put differently, various features of the operations described below correspond to various embodiments described above. The exemplary methods shown in FIGS. 9-11 can be used cooperatively (e.g., with each other and with other procedures described herein) to provide benefits, advantages, and/or solutions to problems described herein. Although the exemplary methods are illustrated in FIGS. 9-11 by specific blocks in particular orders, the operations corresponding to the blocks can be performed in different orders than shown and can be combined and/or divided into blocks and/or operations having different functionality than shown. Optional blocks and/or operations are indicated by dashed lines.

Although the following description of FIGS. 9-11 refer to operations between AnLFs and MTLFs of “the” NWDAF, it should be understood that such operations can be performed by an AnLF and an MTLF that are part of different NWDAF instances. Put differently, the NWDAF in this context can be implemented as multiple NWDAF instances.

In particular, FIG. 9 illustrates an exemplary method (e.g., procedure) for a MTLF of an NWDAF of a communication network (e.g., 5GC), according to various embodiments of the present disclosure. The exemplary method shown in FIG. 9 can be performed by an NWDAF (MTLF) or a network node hosting an NWDAF (MTLF), such as described elsewhere herein.

The exemplary method can include the operations of block 930, where the MTLF can receive a message indicating that a first AnLF of the NWDAF is, or is capable of, monitoring drift of an ML model. The exemplary method can also include the operations of block 950, where the MTLF can, based on the message, send a subscription request for drift monitoring notifications, by the first AnLF, that are associated with the ML model. In some embodiments, the exemplary method can also include the operations of block 960, where the MTLF can receive one or more drift monitoring notifications from the first AnLF in accordance with the subscription request.

In some embodiments, the exemplary method can also include the operations of block 910, where the MTLF can send the ML model to one or more AnLFs, including the first AnLF. It should be understood that “sending” an ML model can include sending the information comprising the ML model or a reference (e.g., URL, URI, link, pointer, etc.) to a location from which such information can be retrieved or obtained, according to customary usage of such references. In some of these embodiments, the message (e.g., in block 930) is one of the following:
a registration request (e.g., such as shown in FIG. 6) indicating that the first AnLF is monitoring the ML model, received from the first AnLF after sending the ML model (e.g., in block 910);
a subscription request or an information request for an ML model (e.g., such as shown in FIG. 7), which indicates that the first AnLF is capable of monitoring drift of ML models and is received from the first AnLF before sending the ML model (e.g., in block 910); or
a query response from a common registration repository (e.g., such as shown in FIG. 8), which indicates that the first AnLF is monitoring drift of the ML model and is received from the common registration repository after sending the ML model (e.g., in block 910).

In some of these embodiments, the exemplary method can also include the operations of block 920, where the MTLF can send, to the common registration repository, a query for a list of AnLFs that have registered as monitoring or being capable of monitoring drift of the ML model. In such case, the query response is received from the common registration repository (e.g., in block 930) in response to the query.

In other of these embodiments, the exemplary method can also include the operations of block 940, where the MTLF can send the AnLF a response indicating acknowledgement of the registration request, subscription request, or information request received from the first AnLF (e.g., in block 930).

In various embodiments, the message (e.g., in block 930) can include one or more of the following information:
a unique identifier of the ML model;
an identifier of the first AnLF or of a DDLF of the first AnLF that is, or is capable of, performing the drift monitoring;
one or more analytics identifiers associated with the drift monitoring;
one or more ML model identifiers associated with the drift monitoring;
an identifier of an analytics target for which the drift monitoring is being performed;
an address for drift monitoring subscription requests;
filtering criteria for the drift monitoring; and
an ML model subscription identifier.

In some of these embodiments one or more of the following applies:
the subscription request is sent (e.g., in block 950) to the address for drift monitoring subscription requests, included in the message; and
the subscription request includes at least a portion of the information included with the message.

In addition, FIG. 10 illustrates an exemplary method (e.g., procedure) for an AnLF of a NWDAF of a communication network (e.g., 5GC), according to various embodiments of the present disclosure. The exemplary method shown in FIG. 10 can be performed by an NWDAF (AnLF) or a network node hosting an NWDAF (AnLF), such as described elsewhere herein.

The exemplary method can include the operations of block 1020, where the AnLF can send a message indicating that the AnLF is, or is capable of, monitoring drift of an ML model. The exemplary method can also include the operations of block 1040, where the AnLF can subsequently receive, from an MTLF of the NWDAF, a subscription request for drift monitoring notifications associated with the ML model.

In some embodiments, the exemplary method can also include the operations of block 1010, where the AnLF can receive the ML model from the MTLF. It should be understood that “receiving” an ML model can include receiving the information comprising the ML model or a reference (e.g., URL, URI, link, pointer, etc.) to a location from which such information can be retrieved or obtained, according to customary usage of such references. In some of these embodiments, the message (e.g., in block 1020) is one of the following:
a registration request (e.g., such as shown in FIG. 6) indicating that the AnLF is monitoring the ML model, with the registration request being sent the MTLF after receiving the ML model (e.g., in block 1010);
a subscription request or an information request for an ML model (e.g., such as shown in FIG. 7), which indicates that the AnLF is capable of monitoring drift of ML models and is sent to the MTLF before receiving the ML model (e.g., in block 1010); or
a registration request to a common registration repository (e.g., such as shown in FIG. 8), which indicates that the first AnLF is monitoring drift of the ML model and is sent to the common registration repository after receiving the ML model (e.g., in block 1010).
   In some of these embodiments, the exemplary method can also include the operations of block 1030, where the AnLF can receive, from the AnLF or the common registration repository, a response indicating acknowledgement of the message.

In various embodiments, the message sent in block 1020 can include any of the information included in the message received in block 930 of FIG. 9. In some of these embodiments, one or more of the following applies:
the subscription request is received (e.g., in block 1040) at the address for drift monitoring subscription requests, included in the message; and
the subscription request includes at least a portion of the information included with the message.

In some embodiments, the exemplary method can also include the operations of blocks 1050-1070. In block 1050, the AnLF can applying the ML model to raw data acquired by the AnLF to obtain predictions for analytics associated with the communication network. In blocks 1060-1070, the AnLF can monitor for drift associated with the ML model and based on the monitoring, send one or more drift monitoring notifications to the MTLF in accordance with the subscription request.

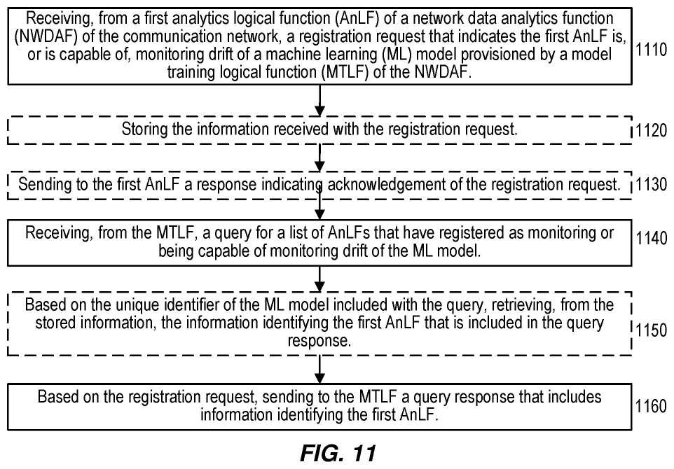

In addition, FIG. 11 illustrates an exemplary method (e.g., procedure) for a common registration repository of a communication network (e.g., 5GC), according to various embodiments of the present disclosure. The exemplary method shown in FIG. 11 can be performed by common registration repository (e.g., UDM, ADRF, etc.) such as described elsewhere herein, or by a network node hosting the same.

The exemplary method can include the operations of block 1110, where the common registration repository can receive, from a first AnLF of an NWDAF of the communication network, a registration request that indicates the first AnLF is, or is capable of, monitoring drift of an ML model provisioned by an MTLF of the NWDAF. The exemplary method can also include the operations of block 1140, where the common registration repository can receive, from the MTLF, a query for a list of AnLFs that have registered as monitoring or being capable of monitoring drift of the ML model. The exemplary method can also include the operations of block 1160, where the common registration repository can, based on the registration request, send to the MTLF a query response that includes information identifying the first AnLF.

In some embodiments, the exemplary method can also include the operations of block 1130, where the common registration repository can send the first AnLF a response indicating acknowledgement of the registration request.

In various embodiments, the registration request received in block 1110 can include any of the information included in the message received in block 930 of FIG. 9.

In some of these embodiments, the query includes the unique identifier of the ML model and the exemplary method also includes the operations of blocks 1120 and 1150, where the common registration repository stores the information received with the registration request and based on the unique identifier of the ML model included with the query (e.g., in block 1140), retrieves, from the stored information, the information identifying the first AnLF that is included in the query response (e.g., in block 1160).

In some embodiments, the common registration repository is a UDR of a 5GC. In other embodiments, the common registration repository is an ADRF of a 5GC.

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

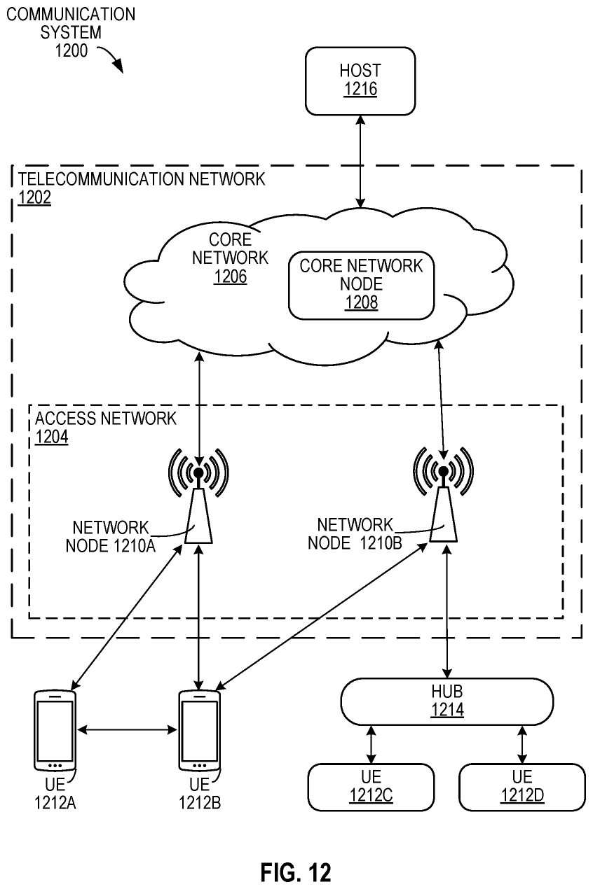

FIG. 12 shows an example of a communication system 1200 in accordance with some embodiments. In this example, communication system 1200 includes a telecommunication network 1202 that includes an access network 1204 (e.g., RAN) and a core network 1206, which includes one or more core network nodes 1208. Access network 1204 includes one or more access network nodes, such as network nodes 1210a-b (one or more of which may be generally referred to as network nodes 1210), or any other similar 3GPP access node or non-3GPP access point. Network nodes 1210 facilitate direct or indirect connection of UEs, such as by connecting UEs 1212a-d (one or more of which may be generally referred to as UEs 1212) to core network 1206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1200 may include any number of wired or wireless networks, network nodes, UEs, and/or any other components or systems that may facilitate or participate in the communication of data and/or signals whether via wired or wireless connections. Communication system 1200 may include and/or interface with any type of communication, telecommunication, data, cellular, radio network, and/or other similar type of system.

UEs 1212 may be any of a wide variety of communication devices, including wireless devices arranged, configured, and/or operable to communicate wirelessly with network nodes 1210 and other communication devices. Similarly, network nodes 1210 are arranged, capable, configured, and/or operable to communicate directly or indirectly with UEs 1212 and/or with other network nodes or equipment in telecommunication network 1202 to enable and/or provide network access, such as wireless network access, and/or to perform other functions, such as administration in telecommunication network 1202.

In the depicted example, core network 1206 connects network nodes 1210 to one or more hosts, such as host 1216. These connections may be direct or indirect via one or more intermediary networks or devices. In other examples, network nodes may be directly coupled to hosts. Core network 1206 includes one more core network nodes (e.g., core network node 1208) that are structured with hardware and software components. Features of these components may be substantially similar to those described with respect to the UEs, network nodes, and/or hosts, such that the descriptions thereof are generally applicable to the corresponding components of core network node 1208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1216 may be under the ownership or control of a service provider other than an operator or provider of access network 1204 and/or telecommunication network 1202, and may be operated by the service provider or on behalf of the service provider. Host 1216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a specific example, host 716 and/or core network node 708 can be configured as NWDAFs (including logical functions thereof) or common registration repositories (e.g., ADRF), with the capability to perform various exemplary methods (e.g., procedures) described above.

As a whole, communication system 1200 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1202 is a cellular network that implements 3GPP standardized features. Accordingly, telecommunication network 1202 may support network slicing to provide different logical networks to different devices that are connected to telecommunication network 1202. For example, telecommunication network 1202 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1212 are configured to transmit and/or receive information without direct human interaction. For instance, a UE may be designed to transmit information to access network 1204 on a predetermined schedule, when triggered by an internal or external event, or in response to requests from access network 1204. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, hub 1214 communicates with access network 1204 to facilitate indirect communication between one or more UEs (e.g., UE 1212c and/or 1212d) and network nodes (e.g., network node 1210b). In some examples, hub 1214 may be a controller, router, content source and analytics, or any of the other communication devices described herein regarding UEs. For example, hub 1214 may be a broadband router enabling access to core network 1206 for the UEs. As another example, hub 1214 may be a controller that sends commands or instructions to one or more actuators in the UEs. Commands or instructions may be received from the UEs, network nodes 1210, or by executable code, script, process, or other instructions in hub 1214. As another example, hub 1214 may be a data collector that acts as temporary storage for UE data and, in some embodiments, may perform analysis or other processing of the data. As another example, hub 1214 may be a content source. For example, for a UE that is a VR headset, display, loudspeaker or other media delivery device, hub 1214 may retrieve VR assets, video, audio, or other media or data related to sensory information via a network node, which hub 1214 then provides to the UE either directly, after performing local processing, and/or after adding additional local content. In still another example, hub 1214 acts as a proxy server or orchestrator for the UEs, in particular in if one or more of the UEs are low energy IoT devices.

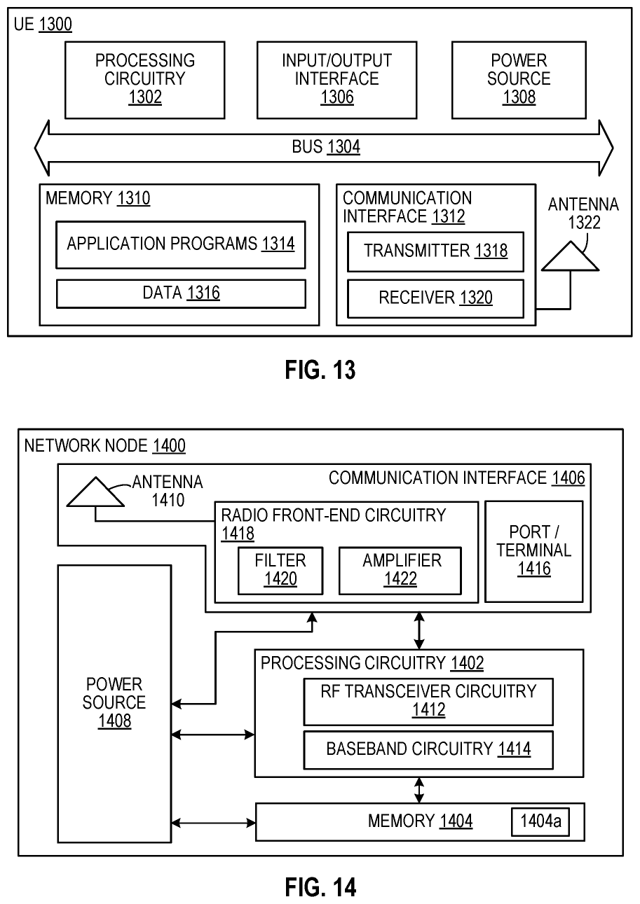

FIG. 13 shows a UE 1300 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

UE 1300 includes processing circuitry 1302 that is operatively coupled via a bus 1304 to an input/output interface 1306, a power source 1308, a memory 1310, a communication interface 1312, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

Processing circuitry 1302 is configured to process instructions and data and may be configured to implement any sequential state machine operative to execute instructions stored as machine-readable computer programs in memory 1310. Processing circuitry 1302 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1302 may include multiple central processing units (CPUs).

In the example, input/output interface 1306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1308 is structured as a battery or battery pack. Other types of power sources, such as an external power source (e.g., an electricity outlet), photovoltaic device, or power cell, may be used. Power source 1308 may further include power circuitry for delivering power from power source 1308 itself, and/or an external power source, to the various parts of UE 1300 via input circuitry or an interface such as an electrical power cable. Delivering power may be, for example, for charging of power source 1308. Power circuitry may perform any formatting, converting, or other modification to the power from power source 1308 to make the power suitable for the respective components of UE 1300 to which power is supplied.

Memory 1310 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1310 includes one or more application programs 1314, such as an operating system, web browser application, a widget, gadget engine, or other application, and corresponding data 1316. Memory 1310 may store, for use by UE 1300, any of a variety of various operating systems or combinations of operating systems.

Memory 1310 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 1310 may allow UE 1300 to access instructions, application programs and the like, stored on transitory or non-transitory memory media, to off-load data, or to upload data. An article of manufacture, such as one utilizing a communication system may be tangibly embodied as or in memory 1310, which may be or comprise a device-readable storage medium.

Processing circuitry 1302 may be configured to communicate with an access network or other network using communication interface 1312. Communication interface 1312 may comprise one or more communication subsystems and may include or be communicatively coupled to an antenna 1322. Communication interface 1312 may include one or more transceivers used to communicate, such as by communicating with one or more remote transceivers of another device capable of wireless communication (e.g., another UE or a network node in an access network). Each transceiver may include a transmitter 1318 and/or a receiver 1320 appropriate to provide network communications (e.g., optical, electrical, frequency allocations, and so forth). Moreover, transmitter 1318 and receiver 1320 may be coupled to one or more antennas (e.g., 1322) and may share circuit components, software or firmware, or alternatively be implemented separately.

FIG. 14 shows a network node 1400 in accordance with some embodiments. Examples of network nodes include, but are not limited to, access points (e.g., radio access points) and base stations (e.g., radio base stations, Node Bs, eNBs, and gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes (or node-hosted network functions) include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., E-SMLC, LMF), core network nodes or functions (e.g., SGW, MME, UPF, AMF, NWDAF, ADRF, etc.), and/or minimization of drive test (MDT) functions.

Network node 1400 includes processing circuitry 1402, a memory 1404, a communication interface 1406, and a power source 1408. Network node 1400 may be composed of multiple physically separate components (e.g., a NodeB component and a RNC component, or a BTS component and a BSC component, etc.), which may each have their own respective components. In certain scenarios in which network node 1400 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1400 may be configured to support multiple radio access technologies (RATs). In such embodiments, some components may be duplicated (e.g., separate memory 1404 for different RATs) and some components may be reused (e.g., a same antenna 1410 may be shared by different RATs). Network node 1400 may also include multiple sets of the various illustrated components for different wireless technologies integrated into network node 1400, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1400.

Processing circuitry 1402 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1400 components, such as memory 1404, to provide network node 1400 functionality.

In some embodiments, processing circuitry 1402 includes a system on a chip (SOC). In some embodiments, processing circuitry 1402 includes one or more of radio frequency (RF) transceiver circuitry 1412 and baseband processing circuitry 1414. In some embodiments, RF transceiver circuitry 1412 and baseband processing circuitry 1414 may be on separate chips (or sets of chips), boards, or units, such as radio units and digital units. In alternative embodiments, part or all of RF transceiver circuitry 1412 and baseband processing circuitry 1414 may be on the same chip or set of chips, boards, or units.

Memory 1404 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1402. Memory 1404 may store any suitable instructions, data, or information, including a computer program, software, an application including one or more of logic, rules, code, tables, and/or other instructions (collectively denoted computer program product 1404a) capable of being executed by processing circuitry 1402 and utilized by network node 1400. Memory 1404 may be used to store any calculations made by processing circuitry 1402 and/or any data received via communication interface 1406. In some embodiments, processing circuitry 1402 and memory 1404 is integrated.

Communication interface 1406 is used in wired or wireless communication of signaling and/or data between a network node, access network, and/or UE. As illustrated, communication interface 1406 comprises port(s)/terminal(s) 1416 to send and receive data, for example to and from a network over a wired connection. Communication interface 1406 also includes radio front-end circuitry 1418 that may be coupled to, or in certain embodiments a part of, antenna 1410. Radio front-end circuitry 1418 comprises filters 1420 and amplifiers 1422. Radio front-end circuitry 1418 may be connected to an antenna 1410 and processing circuitry 1402. The radio front-end circuitry may be configured to condition signals communicated between antenna 1410 and processing circuitry 1402. Radio front-end circuitry 1418 may receive digital data that is to be sent out to other network nodes or UEs via a wireless connection. Radio front-end circuitry 1418 may convert the digital data into a radio signal having the appropriate channel and bandwidth parameters using a combination of filters 1420 and/or amplifiers 1422. The radio signal may then be transmitted via antenna 1410. Similarly, when receiving data, antenna 1410 may collect radio signals which are then converted into digital data by radio front-end circuitry 1418. The digital data may be passed to processing circuitry 1402. In other embodiments, the communication interface may comprise different components and/or different combinations of components.

In certain alternative embodiments, network node 1400 does not include separate radio front-end circuitry 1418, instead, processing circuitry 1402 includes radio front-end circuitry and is connected to antenna 1410. Similarly, in some embodiments, all or some of RF transceiver circuitry 1412 is part of communication interface 1406. In still other embodiments, communication interface 1406 includes one or more ports or terminals 1416, radio front-end circuitry 1418, and RF transceiver circuitry 1412, as part of a radio unit (not shown), and communication interface 1406 communicates with baseband processing circuitry 1414, which is part of a digital unit (not shown).

Antenna 1410 may include one or more antennas, or antenna arrays, configured to send and/or receive wireless signals. Antenna 1410 may be coupled to radio front-end circuitry 1418 and may be any type of antenna capable of transmitting and receiving data and/or signals wirelessly. In certain embodiments, antenna 1410 is separate from network node 1400 and connectable to network node 1400 through an interface or port.

Antenna 1410, communication interface 1406, and/or processing circuitry 1402 may be configured to perform any receiving operations and/or certain obtaining operations described herein as being performed by the network node. Any information, data and/or signals may be received from a UE, another network node and/or any other network equipment. Similarly, antenna 1410, communication interface 1406, and/or processing circuitry 1402 may be configured to perform any transmitting operations described herein as being performed by the network node. Any information, data and/or signals may be transmitted to a UE, another network node and/or any other network equipment.

Power source 1408 provides power to the various components of network node 1400 in a form suitable for the respective components (e.g., at a voltage and current level needed for each respective component). Power source 1408 may further comprise, or be coupled to, power management circuitry to supply the components of network node 1400 with power for performing the functionality described herein. For example, network node 1400 may be connectable to an external power source (e.g., the power grid, an electricity outlet) via an input circuitry or interface such as an electrical cable, whereby the external power source supplies power to power circuitry of power source 1408. As a further example, power source 1408 may comprise a source of power in the form of a battery or battery pack which is connected to, or integrated in, power circuitry. The battery may provide backup power should the external power source fail.

Embodiments of network node 1400 may include additional components beyond those shown in FIG. 14 for providing certain aspects of the network node's functionality, including any of the functionality described herein and/or any functionality necessary to support the subject matter described herein. For example, network node 1400 may include user interface equipment to allow input of information into network node 1400 and to allow output of information from network node 1400. This may allow a user to perform diagnostic, maintenance, repair, and other administrative functions for network node 1400.

As a specific example, network node 1400 can be configured as NWDAF (including logical functions thereof) or a common registration repository (e.g., ADRF), with the capability to perform various exemplary methods (e.g., procedures) described above.

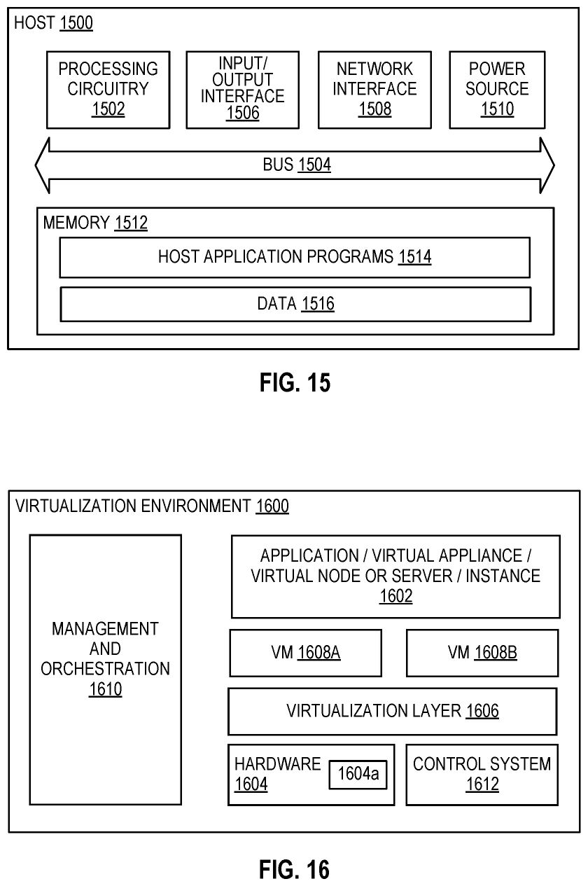

FIG. 15 is a block diagram of a host 1500, which may be an embodiment of host 1216 of FIG. 12, in accordance with various aspects described herein. Host 1500 may be or comprise various combinations hardware and/or software, including a standalone server, a blade server, a cloud-implemented server, a distributed server, a virtual machine, container, or processing resources in a server farm. Host 1500 may provide one or more services to one or more UEs.

Host 1500 includes processing circuitry 1502 that is operatively coupled via a bus 1504 to an input/output interface 1506, a network interface 1508, a power source 1510, and a memory 1512. Other components may be included in other embodiments. Features of these components may be substantially similar to those described with respect to the devices of previous figures, such as FIGS. 13 and 14, such that the descriptions thereof are generally applicable to the corresponding components of host 1500.

Memory 1512 may include one or more computer programs including one or more host application programs 1514 and data 1516, which may include user data, e.g., data generated by a UE for host 1500 or data generated by host 1500 for a UE. Embodiments of host 1500 may utilize only a subset or all of the components shown. Host application programs 1514 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1514 may also provide for user authentication and licensing checks and may periodically report health, routes, and content availability to a central node, such as a device in or on the edge of a core network. Accordingly, host 1500 may select and/or indicate a different host for over-the-top services for a UE. Host application programs 1514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

As a specific example, host 1500 can be configured as NWDAF (including logical functions thereof) or a common registration repository (e.g., ADRF), with the capability to perform various exemplary methods (e.g., procedures) described above.

FIG. 16 is a block diagram illustrating a virtualization environment 1600 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1602 (which may alternatively be called software instances, virtual appliances, network functions, virtual nodes, virtual network functions, etc.) are run in the virtualization environment 1600 to implement some of the features, functions, and/or benefits of some of the embodiments disclosed herein.

Hardware 1604 includes processing circuitry, memory that stores software and/or instructions (collectively denoted computer program product 1604a) executable by hardware processing circuitry, and/or other hardware devices as described herein, such as a network interface, input/output interface, and so forth. Software may be executed by the processing circuitry to instantiate one or more virtualization layers 1606 (also referred to as hypervisors or virtual machine monitors (VMMs)), provide VMs 1608a and 1608b (one or more of which may be generally referred to as VMs 1608), and/or perform any of the functions, features and/or benefits described in relation with some embodiments described herein. The virtualization layer 1606 may present a virtual operating platform that appears like networking hardware to the VMs 1608.

VMs 1608 comprise virtual processing, virtual memory, virtual networking or interface and virtual storage, and may be run by a corresponding virtualization layer 1606. Different embodiments of the instance of a virtual appliance 1602 may be implemented on one or more of VMs 1608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 1608 may be a software implementation of a physical machine that runs programs as if they were executing on a physical, non-virtualized machine. Each VM 1608, and that part of hardware 1604 that executes that VM, be it hardware dedicated to that VM and/or hardware shared by that VM with others of the VMs, forms separate virtual network elements. Still in the context of NFV, a virtual network function (VNF) is responsible for handling specific network functions that run in one or more VMs 1608 on top of the hardware 1604 and corresponds to the application 1602.

As a specific example, virtualization environment 1600 can host various virtual nodes 1602 that implement NWDAFs (including logical functions thereof) and/or common registration repositories (e.g., ADRF) having the capability to perform various exemplary methods (e.g., procedures) described above.

Hardware 1604 may be implemented in a standalone network node with generic or specific components. Hardware 1604 may implement some functions via virtualization. Alternatively, hardware 1604 may be part of a larger cluster of hardware (e.g. such as in a data center or CPE) where many hardware nodes work together and are managed via management and orchestration 1610, which, among others, oversees lifecycle management of applications 1602. In some embodiments, hardware 1604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1612 which may alternatively be used for communication between hardware nodes and radio units.

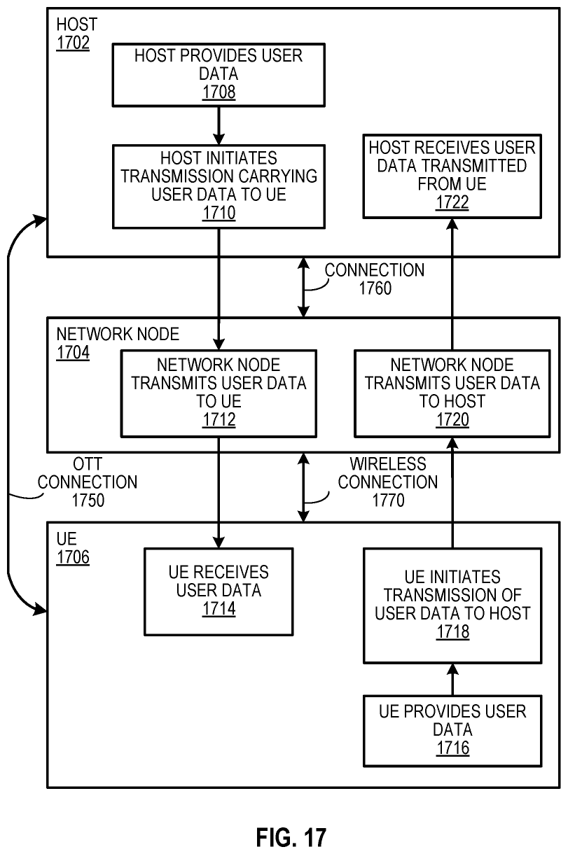

FIG. 17 shows a communication diagram of a host 1702 communicating via a network node 1704 with a UE 1706 over a partially wireless connection in accordance with some embodiments. Example implementations, in accordance with various embodiments, of the UE (such as a UE 1212a of FIG. 12 and/or UE 1300 of FIG. 13), network node (such as network node 1210a of FIG. 12 and/or network node 1400 of FIG. 14), and host (such as host 1216 of FIG. 12 and/or host 1500 of FIG. 15) discussed in the preceding paragraphs will now be described with reference to FIG. 17.

Like host 1500, embodiments of host 1702 include hardware, such as a communication interface, processing circuitry, and memory. Host 1702 also includes software, which is stored in or accessible by host 1702 and executable by the processing circuitry. The software includes a host application that may be operable to provide a service to a remote user, such as UE 1706 connecting via an over-the-top (OTT) connection 1750 extending between UE 1706 and host 1702. In providing the service to the remote user, a host application may provide user data which is transmitted using OTT connection 1750.

Network node 1704 includes hardware enabling it to communicate with host 1702 and UE 1706. Connection 1760 may be direct or pass through a core network (like core network 1206 of FIG. 12) and/or one or more other intermediate networks, such as one or more public, private, or hosted networks. For example, an intermediate network may be a backbone network or the Internet.

UE 1706 includes hardware and software, which is stored in or accessible by UE 1706 and executable by the UE's processing circuitry. The software includes a client application, such as a web browser or operator-specific “app” that may be operable to provide a service to a human or non-human user via UE 1706 with the support of host 1702. In host 1702, an executing host application may communicate with the executing client application via OTT connection 1750 terminating at UE 1706 and host 1702. In providing the service to the user, the UE's client application may receive request data from the host's host application and provide user data in response to the request data. OTT connection 1750 may transfer both the request data and the user data. The UE's client application may interact with the user to generate the user data that it provides to the host application through OTT connection 1750.

OTT connection 1750 may extend via a connection 1760 between host 1702 and network node 1704 and via a wireless connection 1770 between network node 1704 and UE 1706 to provide the connection between host 1702 and UE 1706. Connection 1760 and wireless connection 1770, over which OTT connection 1750 may be provided, have been drawn abstractly to illustrate the communication between host 1702 and UE 1706 via network node 1704, without explicit reference to any intermediary devices and the precise routing of messages via these devices.

As an example of transmitting data via OTT connection 1750, in step 1708, host 1702 provides user data, which may be performed by executing a host application. In some embodiments, the user data is associated with a particular human user interacting with UE 1706. In other embodiments, the user data is associated with a UE 1706 that shares data with host 1702 without explicit human interaction. In step 1710, host 1702 initiates a transmission carrying the user data towards UE 1706. Host 1702 may initiate the transmission responsive to a request transmitted by UE 1706. The request may be caused by human interaction with UE 1706 or by operation of the client application executing on UE 1706. The transmission may pass via network node 1704, in accordance with the teachings of the embodiments described throughout this disclosure. Accordingly, in step 1712, network node 1704 transmits to UE 1706 the user data that was carried in the transmission that host 1702 initiated, in accordance with the teachings of the embodiments described throughout this disclosure. In step 1714, UE 1706 receives the user data carried in the transmission, which may be performed by a client application executed on UE 1706 associated with the host application executed by host 1702.

In some examples, UE 1706 executes a client application which provides user data to host 1702. The user data may be provided in reaction or response to the data received from host 1702. Accordingly, in step 1716, UE 1706 may provide user data, which may be performed by executing the client application. In providing the user data, the client application may further consider user input received from the user via an input/output interface of UE 1706. Regardless of the specific manner in which the user data was provided, UE 1706 initiates, in step 1718, transmission of the user data towards host 1702 via network node 1704. In step 1720, in accordance with the teachings of the embodiments described throughout this disclosure, network node 1704 receives user data from UE 1706 and initiates transmission of the received user data towards host 1702. In step 1722, host 1702 receives the user data carried in the transmission initiated by UE 1706.

One or more of the various embodiments improve the performance of OTT services provided to UE 1706 using OTT connection 1750, in which wireless connection 1770 forms the last segment. More precisely, embodiments can facilitate timely indication of ML model drift to an NWDAF (MTLF), which can retrain the ML model before the inaccuracy due to drift reaches an unacceptable level, e.g., in advance of a periodic and/or predefined model retraining event. Alternately, the NWDAF (MTLF) can trigger termination of the ML model when the detected drift and/or inaccuracy becomes too severe. reports. These advantages are facilitated by providing the NWDAF (MTLF) with a way to determine which NWDAF (AnLF) is monitoring drift of the ML model, so the NWDAF (MTLF) can subscribe for drift notifications. In this manner, embodiments can facilitate improved analytics within the network (particularly based on ML models), which can improve network performance. When OTT services are delivered via a network improved in this manner, they become more valuable to both service providers and end users.

In an example scenario, factory status information may be collected and analyzed by host 1702. As another example, host 1702 may process audio and video data which may have been retrieved from a UE for use in creating maps. As another example, host 1702 may collect and analyze real-time data to assist in controlling vehicle congestion (e.g., controlling traffic lights). As another example, host 1702 may store surveillance video uploaded by a UE. As another example, host 1702 may store or control access to media content such as video, audio, VR or AR which it can broadcast, multicast or unicast to UEs. As other examples, host 1702 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring OTT connection 1750 between host 1702 and UE 1706, in response to variations in the measurement results. The measurement procedure and/or the network functionality for reconfiguring the OTT connection may be implemented in software and hardware of host 1702 and/or UE 1706. In some embodiments, sensors (not shown) may be deployed in or in association with other devices through which OTT connection 1750 passes; the sensors may participate in the measurement procedure by supplying values of the monitored quantities exemplified above, or supplying values of other physical quantities from which software may compute or estimate the monitored quantities. The reconfiguring of OTT connection 1750 may include message format, retransmission settings, preferred routing etc.; the reconfiguring need not directly alter the operation of network node 1704. Such procedures and functionalities may be known and practiced in the art. In certain embodiments, measurements may involve proprietary UE signaling that facilitates measurements of throughput, propagation times, latency and the like, by host 1702. The measurements may be implemented in that software causes messages to be transmitted, in particular empty or ‘dummy’ messages, using OTT connection 1750 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

The techniques and apparatus described herein include, but are not limited to, the following enumerated examples:

A1. A method for a model training logical function (MTLF) of a network data analytics function (NWDAF) of a communication network, the method comprising:
receiving a message indicating that a first analytics logical function (AnLF) of the NWDAF is, or is capable of, monitoring drift of a machine learning (ML) model; and
based on the message, sending a subscription request for drift monitoring notifications, from the first AnLF, that are associated with the ML model.
   A2. The method of embodiment A1, further comprising sending the ML model to one or more AnLFs, including the first AnLF.
   A3. The method of embodiment A2, wherein the message is one of the following:
a registration request indicating that the first AnLF is monitoring the ML model, received from the first AnLF after sending the ML model;
a subscription request or an information request for an ML model, which indicates that the first AnLF is capable of monitoring drift of ML models and is received from the first AnLF before sending the ML model; or
a query response from a common registration repository, which indicates that the first AnLF is monitoring drift of the ML model and is received from the common registration repository after sending the ML model.
   A4. The method of embodiment A3, further comprising sending, to the common registration repository, a query for a list of AnLFs that have registered as monitoring or being capable of monitoring drift of the ML model, wherein the query response is received from the common registration repository in response to the query.
   A5. The method of embodiment A3, further comprising sending the AnLF a response indicating acknowledgement of the registration request, subscription request, or information request received from the AnLF.
   A6. The method of any of embodiments A1-A5, wherein the message includes one or more of the following information:
a unique identifier of the ML model;
an identifier of the first AnLF or of a drift detection logical function (DDLF) of the first AnLF that is, or is capable of, performing the drift monitoring;
one or more analytics identifiers associated with the drift monitoring;
one or more ML model identifiers associated with the drift monitoring;
an identifier of an analytics target for which the drift monitoring is being performed;
an address for drift monitoring subscription requests;
filtering criteria for the drift monitoring; and
an ML model subscription identifier.
   A7. The method of embodiment A6, wherein one or more of the following applies:
the subscription request is sent to the address for drift monitoring subscription requests, included in the message; and
the subscription request includes at least a portion of the information included with the message.
   A8. The method of any of embodiments A1-A7, further comprising receiving one or more drift monitoring notifications from the first AnLF in accordance with the subscription request.
   B1. A method for an analytics logical function (AnLF) of a network data analytics function (NWDAF) of a communication network, the method comprising:
sending a message indicating that the AnLF is, or is capable of, monitoring drift of a machine learning (ML) model; and
subsequently receiving, from a model training logical function (MTLF) of the NWDAF, a subscription request for drift monitoring notifications associated with the ML model.
   B2. The method of embodiment B1, further comprising receive the ML model from the MTLF.
   B3. The method of embodiment B2, wherein the message is one of the following:
a registration request indicating that the AnLF is monitoring the ML model, sent to the MTLF after receiving the ML model;
a subscription request or an information request for an ML model, which indicates that the AnLF is capable of monitoring drift of ML models and is sent to the MTLF before receiving the ML model; or
a registration request to a common registration repository, which indicates that the AnLF is monitoring drift of the ML model and is sent to the common registration repository after receiving the ML model.
   B4. The method of embodiment B3, further comprising receiving, from the MTLF or from the common registration repository, a response indicating acknowledgement of the message.
   B5. The method of any of embodiments B1-B4, wherein the message includes one or more of the following information:
a unique identifier of the ML model;
an identifier of the AnLF or of a drift detection logical function (DDLF) of the AnLF that is, or is capable of, performing the drift monitoring;
one or more analytics identifiers associated with the drift monitoring;
one or more ML model identifiers associated with the drift monitoring;
an identifier of an analytics target for which the drift monitoring is being performed;
an address for drift monitoring subscription requests;
filtering criteria for the drift monitoring;
an ML model subscription identifier.
   B6. The method of embodiment B5, wherein one or more of the following applies:
the subscription request is received at the address for drift monitoring subscription requests, included in the message; and
the subscription request includes at least a portion of the information included with the message.
   B7. The method of any of embodiments A1-A7, further comprising:
applying the ML model to raw data acquired by the AnLF to obtain predictions for analytics associated with the communication network;
monitoring for drift associated with the ML model; and
based on the monitoring, sending one or more drift monitoring notifications to the MTLF in accordance with the subscription request.
   C1. A method for a common registration repository of a communication network, the method comprising:
receiving, from a first analytics logical function (AnLF) of a network data analytics function (NWDAF) of the communication network, a registration request that indicates the first AnLF is, or is capable of, monitoring drift of a machine learning (ML) model provisioned by a model training logical function (MTLF) of the NWDAF;
receiving, from the MTLF, a query for a list of AnLFs that have registered as monitoring or being capable of monitoring drift of the ML model; and
based on the registration request, sending to the MTLF a query response that includes information identifying the first AnLF.
   C2. The method of embodiment C1, further comprising sending the first AnLF a response indicating acknowledgement of the registration request.
   C3. The method of any of embodiments C1-C2, wherein the registration request includes one or more of the following information:
a unique identifier of the ML model;
an identifier of the AnLF or of a drift detection logical function (DDLF) of the AnLF that is, or is capable of, performing the drift monitoring;
one or more analytics identifiers associated with the drift monitoring;
one or more ML model identifiers associated with the drift monitoring;
an identifier of an analytics target for which the drift monitoring is being performed;
an address for drift monitoring subscription requests;
filtering criteria for the drift monitoring;
an ML model subscription identifier.
   C4. The method of embodiment C3, wherein the query includes the unique identifier of the ML model and the method further comprises:
storing the information received with the registration request; and
based on the unique identifier of the ML model included with the query, retrieving, from the stored information, the information identifying the first AnLF that is included in the query response.
   C5. The method of any of embodiments C1-C4, wherein the common registration repository is one of the following: a unified data repository (UDR) of a 5G core network (5GC), or an analytics data repository function (ADRF) of a 5GC.
   D1. A model training logical function (MTLF) of a network data analytics function (NWDAF) of a communication network, wherein:
the MTLF is implemented by communication interface circuitry and processing circuitry that are operably coupled; and
the processing circuitry and interface circuitry are configured to perform operations corresponding to any of the methods of embodiments A1-A8.
   D2. A model training logical function (MTLF) of a network data analytics function (NWDAF) of a communication network, the MTLF being configured to perform operations corresponding to any of the methods of embodiments A1-A8.
   D3. A non-transitory, computer-readable medium storing computer-executable instructions that, when executed by processing circuitry associated with a model training logical function (MTLF) of a network data analytics function (NWDAF) of a communication network, configure the MTLF to perform operations corresponding to any of the methods of embodiments A1-A8.
   D4. A computer program product comprising computer-executable instructions that, when executed by processing circuitry associated with a model training logical function (MTLF) of a network data analytics function (NWDAF) of a communication network, configure the MTLF to perform operations corresponding to any of the methods of embodiments A1-A8.
   E1. An analytics logical function (AnLF) of a network data analytics function (NWDAF) of a communication network, wherein:
the AnLF is implemented by communication interface circuitry and processing circuitry that are operably coupled; and
the processing circuitry and interface circuitry are configured to perform operations corresponding to any of the methods of embodiments B1-B7.
   E2. An analytics logical function (AnLF) of a network data analytics function (NWDAF) of a communication network, the AnLF being configured to perform operations corresponding to any of the methods of embodiments B1-B7.
   E3. A non-transitory, computer-readable medium storing computer-executable instructions that, when executed by processing circuitry associated with an analytics logical function (AnLF) of a network data analytics function (NWDAF) of a communication network, configure the AnLF to perform operations corresponding to any of the methods of embodiments B1-B7.
   E4. A computer program product comprising computer-executable instructions that, when executed by processing circuitry associated with an analytics logical function (AnLF) of a network data analytics function (NWDAF) of a communication network, configure the AnLF to perform operations corresponding to any of the methods of embodiments B1-B7.
   F1. A common registration repository of a communication network, wherein:
the common registration repository is implemented by communication interface circuitry and processing circuitry that are operably coupled; and
the processing circuitry and interface circuitry are configured to perform operations corresponding to any of the methods of embodiments C1-C5.
   F2. A common registration repository of a communication network, the common registration repository being configured to perform operations corresponding to any of the methods of embodiments C1-C5.
   F3. A non-transitory, computer-readable medium storing computer-executable instructions that, when executed by processing circuitry associated with a common registration repository of a communication network, configure the common registration repository to perform operations corresponding to any of the methods of embodiments C1-C5.
   F4. A computer program product comprising computer-executable instructions that, when executed by processing circuitry associated with a common registration repository of a communication network, configure the common registration repository to perform operations corresponding to any of the methods of embodiments C1-C5.

1.-38. (canceled)

39. A method for a model training logical function (MTLF) of a network data analytics function (NWDAF) of a communication network, the method comprising:
receiving a message indicating that a first analytics logical function (AnLF) of the NWDAF is, or is capable of, monitoring drift of a machine learning (ML) model; and
based on the message, sending a subscription request for drift monitoring notifications, by the first AnLF, that are associated with the ML model.

40. The method of claim 39, further comprising sending the ML model to one or more AnLFs including the first AnLF, wherein the received message is one of the following:
a registration request indicating that the first AnLF is monitoring the ML model, received from the first AnLF after sending the ML model;
a further subscription request or an information request for an ML model, which indicates that the first AnLF is capable of monitoring drift of ML models and is received from the first AnLF before sending the ML model; or
a query response from a common registration repository, which indicates that the first AnLF is monitoring drift of the ML model and is received from the common registration repository after sending the ML model.

41. The method of claim 40, further comprising sending, to the common registration repository, a query for a list of AnLFs that have registered as monitoring or being capable of monitoring drift of the ML model, wherein the query response is received from the common registration repository in response to the query.

42. The method of claim 40, further comprising sending to the AnLF a response indicating acknowledgement of the registration request, the further subscription request, or the information request received from the first AnLF.

43. The method of claim 39, wherein the message includes one or more of the following information:
a unique identifier of the ML model;
an identifier of the first AnLF or of a drift detection logical function (DDLF) of the first AnLF that is, or is capable of, performing the drift monitoring;
one or more analytics identifiers associated with the drift monitoring;
one or more ML model identifiers associated with the drift monitoring;
an identifier of an analytics target for which the drift monitoring is being performed;
an address for drift monitoring subscription requests;
filtering criteria for the drift monitoring; and
an ML model subscription identifier.

44. The method of claim 43, wherein one or more of the following applies:
the subscription request is sent to the address for drift monitoring subscription requests, included in the message; and
the subscription request includes at least a portion of the information included with the message.

45. The method of claim 39, further comprising receiving one or more drift monitoring notifications from the first AnLF in accordance with the subscription request.

46. A method for an analytics logical function (AnLF) of a network data analytics function (NWDAF) of a communication network, the method comprising:
sending a message indicating that the AnLF is, or is capable of, monitoring drift of a machine learning (ML) model; and
subsequently receiving, from a model training logical function (MTLF) of the NWDAF, a subscription request for drift monitoring notifications associated with the ML model.

47. The method of claim 46, further comprising receiving the ML model from the MTLF, wherein the message is one of the following:
a registration request indicating that the AnLF is monitoring the ML model, sent to the MTLF after receiving the ML model;
a further subscription request or an information request for an ML model, which indicates that the AnLF is capable of monitoring drift of ML models and is sent to the MTLF before receiving the ML model; or
a registration request to a common registration repository, which indicates that the AnLF is monitoring drift of the ML model and is sent to the common registration repository after receiving the ML model.

48. The method of claim 47, further comprising receiving, from the MTLF or from the common registration repository, a response indicating acknowledgement of the message.

49. The method of claim 46, wherein the message includes one or more of the following information:
a unique identifier of the ML model;
an identifier of the AnLF or of a drift detection logical function (DDLF) of the AnLF that is, or is capable of, performing the drift monitoring;
one or more analytics identifiers associated with the drift monitoring;
one or more ML model identifiers associated with the drift monitoring;
an identifier of an analytics target for which the drift monitoring is being performed;
an address for drift monitoring subscription requests;
filtering criteria for the drift monitoring;
an ML model subscription identifier.

50. The method of claim 49, wherein one or more of the following applies:
the subscription request is received at the address for drift monitoring subscription requests, included in the message; and
the subscription request includes at least a portion of the information included with the message.

51. The method of claim 46, further comprising:
applying the ML model to raw data acquired by the AnLF to obtain predictions for analytics associated with the communication network;
monitoring for drift associated with the ML model; and
based on the monitoring, sending one or more drift monitoring notifications to the MTLF in accordance with the subscription request.

52. A method for a common registration repository of a communication network, the method comprising:
receiving, from a first analytics logical function (AnLF) of a network data analytics function (NWDAF) of the communication network, a registration request that indicates the first AnLF is, or is capable of, monitoring drift of a machine learning (ML) model provisioned by a model training logical function (MTLF) of the NWDAF;
receiving from the MTLF a query for a list of AnLFs that have registered as monitoring or being capable of monitoring drift of the ML model; and
based on the registration request, sending to the MTLF a query response that includes information identifying the first AnLF.

53. The method of claim 52, further comprising sending to the first AnLF a response indicating acknowledgement of the registration request.

54. The method of claim 52, wherein the registration request includes one or more of the following information:
a unique identifier of the ML model;
an identifier of the first AnLF or of a drift detection logical function (DDLF) of the first AnLF that is, or is capable of, performing the drift monitoring;
one or more analytics identifiers associated with the drift monitoring;
one or more ML model identifiers associated with the drift monitoring;
an identifier of an analytics target for which the drift monitoring is being performed;
an address for drift monitoring subscription requests;
filtering criteria for the drift monitoring;
an ML model subscription identifier.

55. The method of claim 54, wherein the query includes the unique identifier of the ML model and the method further comprises:
storing the information received with the registration request; and
based on the unique identifier of the ML model included with the query, retrieving, from the stored information, the information identifying the first AnLF that is included in the query response.

56. Network equipment arranged to implement a model training logical function (MTLF) of a network data analytics function (NWDAF) of a communication network, wherein:
the network equipment comprises communication interface circuitry and processing circuitry that are operably coupled; and
the processing circuitry and the communication interface circuitry are configured to perform the method of claim 39.

57. Network equipment arranged to implement an analytics logical function (AnLF) of a network data analytics function (NWDAF) of a communication network, wherein:
the network equipment comprises communication interface circuitry and processing circuitry that are operably coupled; and
the processing circuitry and the communication interface circuitry are configured to perform the method of claim 46.

58. Network equipment arranged to implement a common registration repository of a communication network, wherein:
the network equipment comprises communication interface circuitry and processing circuitry that are operably coupled; and
the processing circuitry and the communication interface circuitry are configured to perform the method of claim 52.
